(19) United States
(12) Patent Application Publication
(10) Pub. No.: US 2022/0041120 A1
(43) Pub. Date: Feb. 10, 2022

(54) License Plate Holder

(71) Applicant: Dae Kwon CHUNG, Fullerton, CA (US)

(72) Inventor: Dae Kwon CHUNG, Fullerton, CA (US)

(21) Appl. No.: 16/987,727

(22) Filed: Aug. 7, 2020

(51) Int. Cl. B60R 13/10; G09F 7/18; B60R 11/04; H04N 5/225

(52) U.S. Cl. CPC B60R 13/105; G09F 7/18; B60R 11/04; B60R 2011/004; G09F 2007/1865; G09F 2007/1895; H04N 5/2254

(57) ABSTRACT

A license plate holder has a perimeter capable of holding a number plate. The perimeter has a upper rim, a right rim, a left rim and a lower rim forming an opening through which a license place may be visible. The license plate has both at least one camera lens and at least one proximity sensor attached to it.

### SUMMARY

An improved license plate holder is presented herein.

There are several patents related to license plate holders with one or more cameras. Also, there are several patents related to proximity sensors on a bumper of a vehicle. Some of the examples are (1) U.S. Pat. No. 4,663,542, by Buck et al, (2) U.S. Pat. No. 5,229,975, by Truesdell, et al, (3) U.S. Pat. No. 6,441,623, by Moon, (4) U.S. Pat. No. 7,195,405, by Son, (5) U.S. Pat. No. 8,4332,446, by Son, and (6) U.S. Pat. No. 9,088,282, by Holenarsipur, et al. Applicant hereby incorporates each of the above cited patents in its entirety herein. Although a camera has been mounted on a license plate holder, there has been no disclosures for a license plate holder with both a camera and a proximity sensor. Thus, a license plate holder with both one or more cameras and one or more proximity sensors is needed and is descried herein.

A license plate holder described herein has a perimeter. The perimeter is formed by a upper rim, a right rim, a left rim and a lower rim forming an opening. The perimeter is capable of holding a license plate or a number plate so that the license plate is visible through the opening and the perimeters securely holds a first camera lens and a first proximity sensor on the perimeter. The first camera lens is attached to the upper rim and the first proximity sensor is attached to the lower rim.

Various alternate designs may be obtained by placing the first camera lens and other additional camera lenses (such as a second camera lens) and the first proximity sensor and other additional proximity sensors (such as a second proximity sensor) at various rims. The examples, including but not limited to, are (1) the first camera lens is attached to the upper rim and the first proximity sensor is attached to the left rim, (2) the first camera lens is attached to the upper rim and the first proximity sensor is attached to the right rim, (3) the first camera lens is attached to the upper rim and the first proximity sensor is attached to the left rim with a second proximity sensor attached to the right rim, (4) the first camera lens is attached to the lower rim and the first proximity sensor is attached to the upper rim, (5) the first camera lens is attached to the lower rim and the first proximity sensor is attached to the left rim, (6) the first camera lens is attached to the lower rim and the first proximity sensor is attached to the right rim, (7) the first camera lens is attached to the lower rim and the first proximity sensor is attached to the left rim with a second proximity sensor attached to the right rim, (8) the first camera lens is attached to the upper rim and the first proximity sensor is also attached to the upper rim, (9) the first camera lens is attached to the lower rim and the first proximity sensor is also attached to the lower rim, (10) the first camera lens is attached to the upper rim and the first proximity sensor is attached to the left of the first camera lens on the upper rim and the second proximity sensor is attached to the right of the first camera lens on the upper rim, (11) the first camera lens is attached to the lower rim and the first proximity sensor is attached to the left of the first camera lens on the lower rim and the second proximity sensor is attached to the right of the first camera lens on the lower rim, (12) the first camera lens is attached to the left rim and the first proximity sensor is also attached to the left rim, or (13) the first camera lens is attached to the right rim and the first proximity sensor is also attached to the right rim. Additional combinations are available.

The proximity sensors used may be any commercially available sensors, including but not limited to, a microwave radar, any proximity sensors described in the cited prior art referenced and incorporated herein, any proximity sensors for airplanes, ships or non-moving premises, such as a front door of a house or an entrance way. Although a preferred proximity sensor for this license plate holder is a microwave proximity sensors, different proximity sensors may be used or in combination thereof.

Additional variations of the license plate holder may be achieved by having more than one camera lenses mounted on the upper rim and having more than one proximity sensors are mounted on the lower rim. In addition, one or more camera lenses and one or more proximity sensors may be placed on each of the upper rim, left rim, right rim or the lower rim. Also, a camera lens and a proximity sensor may be alternatingly mounted on any of the rims of the license plate holder.

One of the benefits of the license plate holder is that the bumpers of automobiles do not need to be holed or pre-fitted to install proximity sensors or camera lenses. Also, because the license plate holder is easily detachable, the license plate holder as described in this disclosure can be moved from a vehicle to a different vehicle. Moreover, the license plate holder may easily be replaced in contrast to the bumper mounted sensors. Furthermore, the license plate holder does not require modifications to vehicles, such as drilling holes to the bumpers. In addition, a combination of a camera and a proximity sensor for a vehicle may be produced at very low cost compared to installing them directly on a vehicle. This is especially true for older vehicles and other vehicles that does not have the proximate sensors installed by the factory.

### BRIEF DESCRIPTION OF THE DRAWINGS

These and other features, aspects and advantages of the license plate holder will become better understood with reference to the accompanying drawings, wherein:

FIG. 1: the license plate holder,

FIG. 2: another version of the license plate holder,

FIG. 3: another version of the license plate holder,

FIG. 4: another version of the license plate holder,

FIG. 5: another version of the license plate holder,

FIG. 6: another version of the license plate holder,

FIG. 7: another version of the license plate holder,

FIG. 8: another version of the license plate holder,

FIG. 9: another version of the license plate holder, and

FIG. 10: another version of the license plate holder.

### DETAILED DESCRIPTION EMBODIMENTS OF THE INVENTION

A license plate holder is described in detail as shown on the Figs.

FIG. 1 shows the license plate holder 10. A perimeter 15 is formed by four sides 20 which will be referred to as rims.

The perimeter 15 is formed by a upper rim 25, a right rim 30, a left rim 35 and a lower rim 40 forming an opening 45. The perimeter 25 is capable of holding a license plate (not shown) or a number plate so that the license plate is visible through the opening. The perimeter 15 also securely holds a first camera lens 50 and a first proximity sensor 55. The first camera lens 50 is attached to the upper rim 25 and the first proximity sensor 55 is attached to the lower rim 40.

The first camera lens 50 may be mounted on a first camera-mounting platform 60 which may be a strip of material to securely hold the first camera lens 50 or a hole designed to securely hold the first camera lens 50. The first proximity sensor 55 may be mounted on a first proximity-sensor-mounting platform 65 which may be a strip of material to securely hold the first proximity sensor 55 or a hole designed to securely hold the first proximity sensor 55.

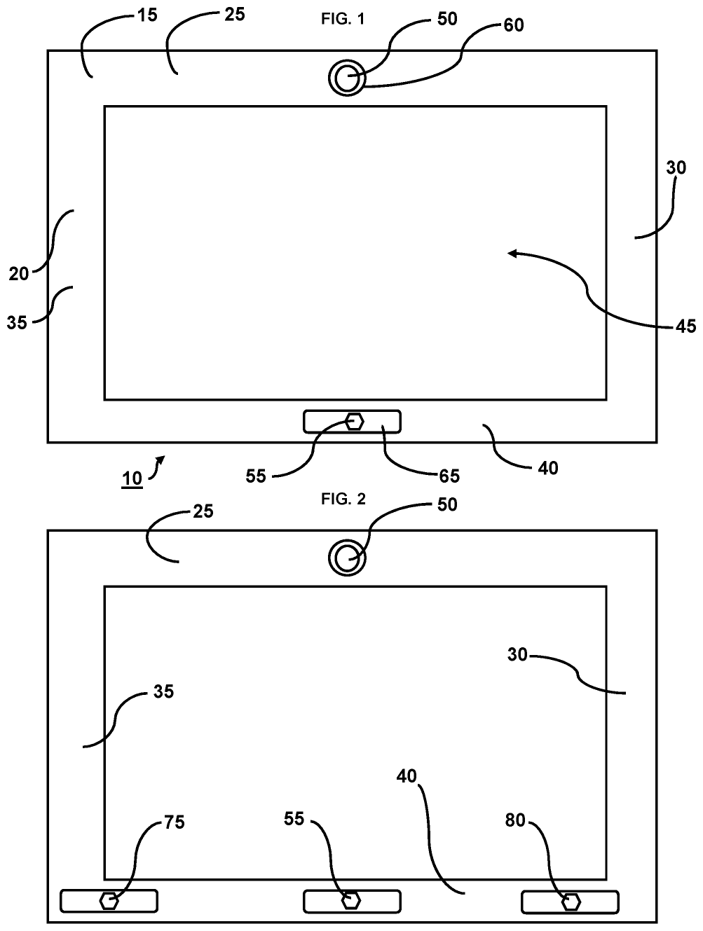

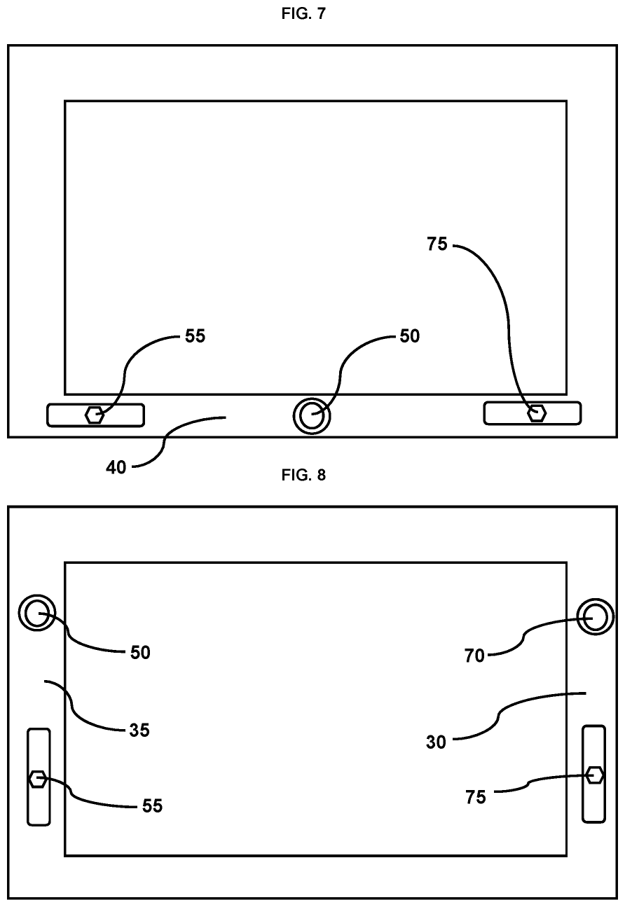

The first proximity-sensor-mounting platform 65 may have a cover (not shown) to protect the first proximity sensor 55. The first proximity sensor 55 may be mounted on the license plate holder without the corresponding proximity-sensor-mounting platform 65. Also, a various alternate designs may be obtained by placing the first camera lens 50 and other additional camera lenses (such as a second camera lens 70, see FIG. 7) and the first proximity sensor 55 and other additional proximity sensors (such as a second proximity sensor 75, See FIG. 2) at various rims.

The perimeter 15 also has vehicle-mounting holes (not shown, but there are often two on the upper rim and two on the lower rim; see FIG. 1 of the U.S. Pat. No. 8,432,446 for an example) for removably attaching the license plate holder 10 to a vehicle.

FIG. 2 shows a variation of the license plate holder 10. The license plate holder 10 has the first camera lens 50 placed on the upper rim 25 and three proximity sensors located on the lower rim 40 (the first proximity sensor 55, the second proximity sensor 75 and the third proximity sensor 80.) Having a plurality of the proximity sensors improve the sensitivity of the overall proximity sensor function (such as detection and distance measurement) as each proximate sensor could be directionally oriented, whether they are mounted on the upper rim 25, the lower rim 40, left rim 35 or the right rim 30. For example, a proximity sensor on the left side of the license plated may be installed facing a bit toward the left side of the back of the car (as looking from behind the car), a proximity sensor at the center of the license plated may be installed facing directly backward of the car and a proximity sensor on the right side of the license plated may be installed facing a bit toward the right side of the back of the car (as looking from behind the car).

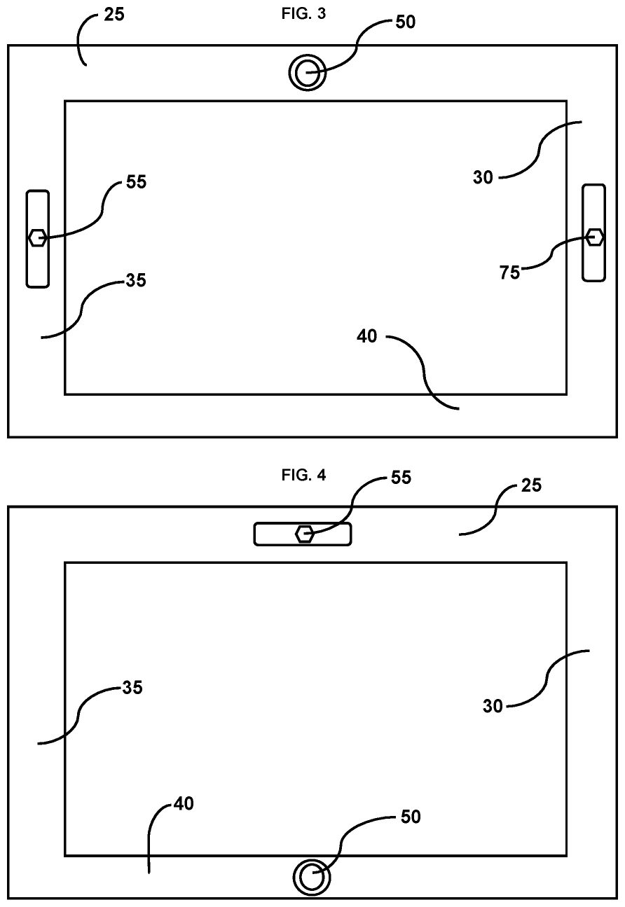

FIG. 3 shows another variation of the license plate holder 10. The license plate holder 10 has the first camera lens 50 placed on the upper rim 25 with the first proximity sensor 55 located on the left rim 35 and the second proximity sensor 75 located on the right rim 30.

FIG. 4 shows another variation of the license plate holder 10. The license plate holder 10 has the first camera lens 50 placed on the lower rim 40 with the first proximity sensor 55 located on the upper rim 25.

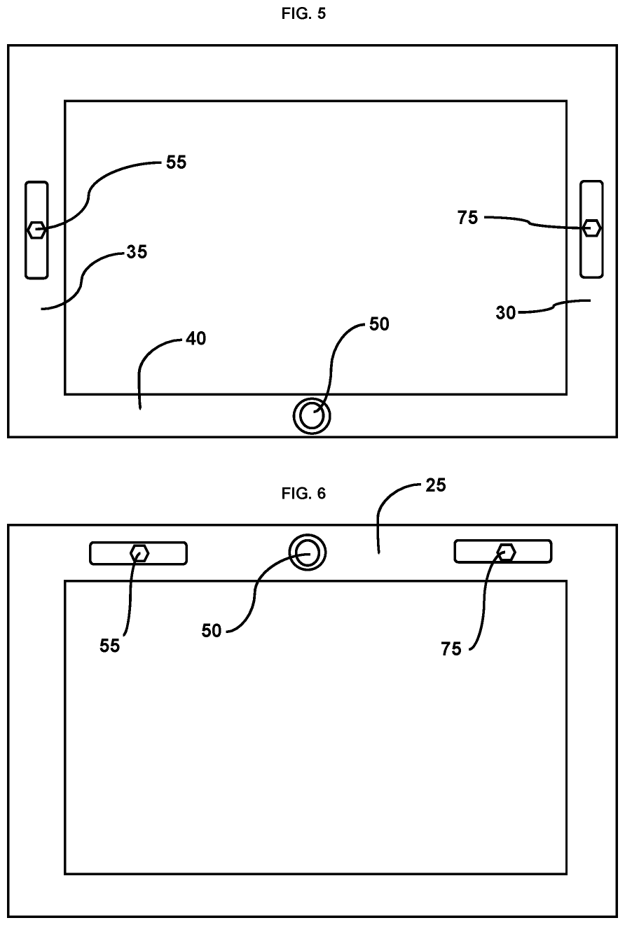

FIG. 5 shows another variation of the license plate holder 10. The license plate holder 10 has the first camera lens 50 placed on the lower rim 40 with the first proximity sensor 55 located on the left rim 35 and the second proximity sensor 75 located on the right rim 30.

FIG. 6 shows another variation of the license plate holder 10. The license plate holder 10 has the first camera lens 50 placed on the upper rim 25 with the first proximity sensor 55 located left of the first camera lens 50 and the second proximity sensor 75 located right of the first camera lens 50, both proximity sensors also located on the upper rim 25.

FIG. 7 shows another variation of the license plate holder 10. The license plate holder 10 has the first camera lens 50 placed on the lower rim 40 with the first proximity sensor 55 located left of the first camera lens 50 and the second proximity sensor 75 located right of the first camera lens 50, both proximity sensors also located on the lower rim 40.

FIG. 8 shows another variation of the license plate holder 10. The license plate holder 10 has the first camera lens 50 placed on the left rim 35 with the first proximity sensor 55 also located on the left rim 35 and the second camera lens 70 placed on the right rim 30 with the second proximity sensor 75 also located on the right rim 30. Although the first camera lens 50 and the second camera lens 70 are placed above the first proximity sensor 55 and the second proximity sensor 75, respectively, another variation may have the first camera lens 50 and the second camera lens 70 placed below the first proximity sensor 55 and the second proximity sensor 75.

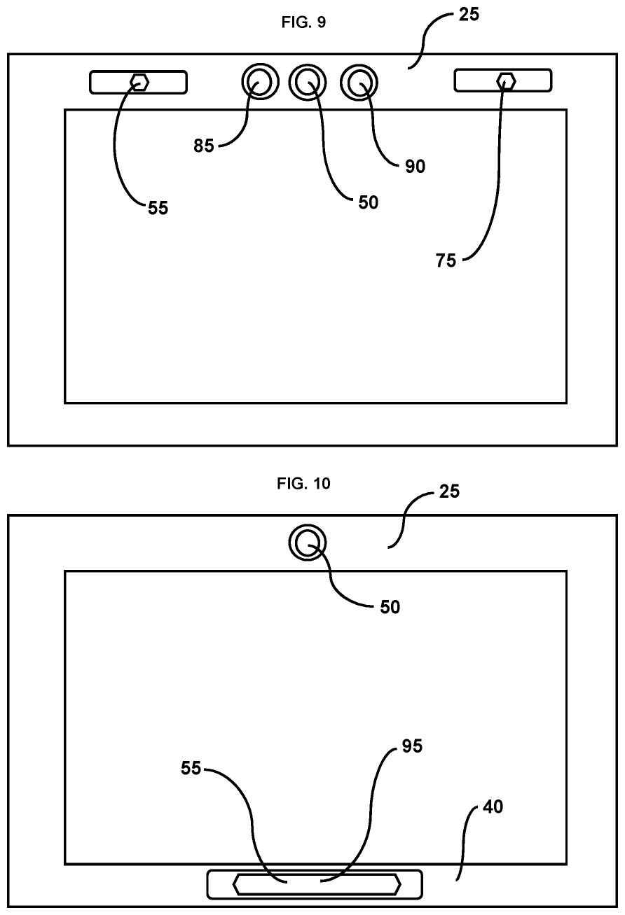

FIG. 9 shows another variation of the license plate holder 10. The license plate holder 10 has the first camera lens 50 placed on the upper rim 25 with a second camera lens 85 placed on the left of the first camera lens 50 and a third camera lens 90 placed on the right of the first camera lens 50. The first proximity sensor 55 is placed on the left of the second camera lens 85 and the second proximity sensor 75 is placed on the right of the third camera lens 90, both proximity sensors placed also on the upper rim 25. Alternate design, although not shown is that the second camera lens 85 and the third camera lens 90 may be replaced by one or more light source, such as LED lights.

FIG. 10 shows another variation of the license plate holder 10. The license plate holder 10 has the first camera lens 50 placed on the upper rim 25 and the first proximity sensor 55 is placed on the lower rim 40. The first proximity sensor 55 shown is an elongated sensor plate 95 (a description of an elongated sensor plate 95 is described in U.S. Pat. No. 644,623, by Moon).

Although it is not shown in any of the Figs, a cover may be placed on any of the proximity sensors so that the sensors may be protected. Also, a transparent cover may be placed on any of the camera lenses to protect the lenses from becoming dirty or being damaged.

In addition, the proximity sensors used may be any commercially available sensors, including but not limited to, a microwave radar, any proximity sensors described in the cited prior art referenced and incorporated herein, any proximity sensors for automobiles and/or any proximity sensors for airplanes, ships or non-moving premises, such as a front door of a house or an entry/exit way. Although a preferred proximity sensor for this license plate holder is a microwave radar proximity sensors, different proximity sensors may be used or in combination thereof.

The images from the camera may be displayed on a video display of the vehicle, as well as being recorded into a recorder. Likewise, signals from the proximity sensors may also be displayed by a display (the same one or a separate display), as well as linked to a proximity alarms. Either or both the cameras and the proximity sensors may be connected to a main processor that controls any of or all of the video displays, the recorder and the proximity alarms.

While the description, drawings and references have presented, shown and described with reference to different embodiments thereof, it will be appreciated by those skilled in the art that variations in form, detail, compositions and operation may be made without departing from the spirit and scope of the disclosure. For an example, the license plate holder is described to be installed on the rear of a vehicle, but it may be installed on the front of the vehicle. Also, the license plate holder may be installed on the front of the vehicle and another license plate holder may be installed on the rear of the vehicle. In addition, the first camera lens 50 may be attached to the left rim 35 and the first proximity sensor 55 is attached to the right rim, or vise versa. All such uses are in the scope of the description and the claims.

What is claimed is:

1. A license plate holder having a perimeter capable of holding a number plate, wherein the license plate comprises a first camera lens and a first proximity sensor on the perimeter.

2. The license plate holder of claim 1 wherein the perimeter has a upper rim, a right rim, a left rim and a lower rim forming an opening, wherein the first camera lens is attached to the upper rim and the first proximity sensor is attached to the lower rim.

3. The license plate holder of claim 1 wherein the perimeter has a upper rim, a right rim, a left rim and a lower rim forming an opening, wherein the first camera lens is attached to the upper rim and the first proximity sensor is attached to the left rim.

4. The license plate holder of claim 1 wherein the perimeter has a upper rim, a right rim, a left rim and a lower rim forming an opening, wherein the first camera lens is attached to the upper rim and the first proximity sensor is attached to the right rim.

5. The license plate holder of claim 1 wherein the perimeter has a upper rim, a right rim, a left rim and a lower rim forming an opening, wherein the first camera lens is attached to the upper rim and wherein the first proximity sensor is attached to the left rim and a second proximity sensor is attached to the right rim.

6. The license plate holder of claim 1 wherein the perimeter has a upper rim, a right rim, a left rim and a lower rim forming an opening, wherein the first camera lens is attached to the lower rim and the first proximity sensor is attached to the upper rim.

7. The license plate holder of claim 1 wherein the perimeter has a upper rim, a right rim, a left rim and a lower rim forming an opening, wherein the first camera lens is attached to the lower rim and the first proximity sensor is attached to the left rim.

8. The license plate holder of claim 1 wherein the perimeter has a upper rim, a right rim, a left rim and a lower rim forming an opening, wherein the first camera lens is attached to the lower rim and the first proximity sensor is attached to the right rim.

9. The license plate holder of claim 1 wherein the perimeter has a upper rim, a right rim, a left rim and a lower rim forming an opening, wherein the first camera lens is attached to the lower rim and wherein the first proximity sensor is attached to the left rim and a second proximity sensor is attached to the right rim.

10. The license plate holder of claim 1 wherein the perimeter has a upper rim, a right rim, a left rim and a lower rim forming an opening, wherein the first camera lens is attached to the upper rim and the first proximity sensor is also attached to the upper rim.

11. The license plate holder of claim 1 wherein the perimeter has a upper rim, a right rim, a left rim and a lower rim forming an opening, wherein the first camera lens is attached to the lower rim and the first proximity sensor is also attached to the lower rim.

12. The license plate holder of claim 10 wherein the first proximity sensor is attached to the left of the first camera lens on the upper rim and a second proximity sensor is attached to the right of the first camera lens on the upper rim.

13. The license plate holder of claim 11 wherein the first proximity sensor is attached to the left of the first camera lens on the lower rim and a second proximity sensor is attached to the right of the first camera lens on the lower rim.

14. The license plate holder of claim 1 wherein the perimeter has a upper rim, a right rim, a left rim and a lower rim forming an opening, wherein the first camera lens is attached to the left rim and the first proximity sensor is also attached to the left rim.

15. The license plate holder of claim 1 wherein the perimeter has a upper rim, a right rim, a left rim and a lower rim forming an opening, wherein the first camera lens is attached to the right rim and the first proximity sensor is also attached to the right rim.

16. The license plate holder of claim 14 wherein a second camera lens is attached to the right rim and the second proximity sensor is also attached to the right rim.

17. The license plate holder of claim 1 wherein the first proximity sensor uses a microwave radar.

18. The license plate holder of claim 12 wherein the first proximity sensor and the second proximity sensor both use microwave radars.

19. The license plate holder of claim 12 wherein the first proximity sensor uses a microwave radar and the second proximity sensor is not a microwave radar.

20. A license plate holder having a perimeter capable of holding a number plate, wherein the perimeter has a upper rim, a right rim, a left rim and a lower rim forming an opening, and wherein a plurality of camera lenses are mounted on the upper rim and a plurality of proximity sensors are mounted on the lower rim.
